(19) United States
(12) Patent Application Publication
(10) Pub. No.: US 2006/0098243 A1
(43) Pub. Date: May 11, 2006

(54) Determining a gray background value and/or skew of a scanned document

(75) Inventors: Mohamed Nooman Ahmed, Louisville, KY (US); Tomasz Jan Cholewo, Lexington, KY (US); Steven Frank Weed, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 10/983,825

(22) Filed: Nov. 8, 2004

(51) Int. Cl. H04N 1/04

(52) U.S. Cl. 358/474

(57) ABSTRACT

One method for determining a gray background value of a scanned document having left, right, top and bottom edges includes obtaining a scanned image of a horizontal strip which includes at least one portion of the document and which includes at least one non-document area, and includes creating a histogram of pixel values, of the horizontal strip, inside the document edges while excluding from the histogram pixel values, of the horizontal strip, located outside the document edges. Another method for determining a gray background value includes obtaining a scanned image of a vertical strip. One method for determining skew of a scanned document includes obtaining a scanned image, which includes a leading document edge, using vertically-displaced successive horizontal scan lines, includes determining points of the leading edge, and includes fitting a line to the points. Another method for determining a skew uses horizontally-displaced successive vertical scan lines.

### TECHNICAL FIELD

The present invention relates generally to scanners, and more particularly to a method for determining a gray background value of a scanned document and to a method for determining skew of a scanned document.

### BACKGROUND OF THE INVENTION

Scanners are used to scan an image to create a scanned image which can be displayed on a computer monitor, which can be used by a computer program, which can be printed, which can be faxed, etc. A first conventional method for scanning an image uses a scanner including a horizontal scan bar having sensor elements (such as CCD [charge-coupled-device] elements). A document on the scanning area of the scanner is scanned by the scan bar. With the scan bar stationary, the scanner obtains pixel values from the sensor elements for corresponding pixel locations of a portion of the document along the horizontal scan line of the scan bar. The scan bar is moved vertically for vertically-displaced successive horizontal scan lines until a scanned image of the entire scanning area is obtained. In a second conventional method, the scan bar always remains stationary, the document is scanned by moving the document past the scan bar, and the scanning area is considered to be the scanned image. In the first and/or second conventional scanners, the document may be smaller than the scanning area (and hence smaller than the scanned image of the scanning area) and/or skewed with respect to the scanning area.

In one known extension of the first and second conventional methods, the pixel values of the scanned image are adjusted to remove the “gray” background pixel level before the scanned image is displayed on a computer screen, printed, faxed, etc. In another known extension of the first and second conventional methods, the pixel locations are adjusted, based on the slope of a line corresponding to detecting the entire left or right edge of the scanned document, to correct for skew (rotation) of the scanned document before the scanned image is displayed on a computer screen, printed, faxed, etc.

What is needed is an improved method for determining a gray background value of a scanned document and an improved method for determining skew of a scanned document.

### SUMMARY OF THE INVENTION

A first method of the invention is for determining a gray background value of a scanned document having left, right, top and bottom edges. The first method includes several steps. One step includes obtaining a scanned image, having pixel values, of a horizontal strip of a scanning area of a scanner, wherein the horizontal strip includes at least one portion of the document and includes at least one non-document area. Another step includes creating a histogram of the pixel values, of the horizontal strip, located inside the left, right, top and bottom edges of the document while excluding from the histogram the pixel values, of the horizontal strip, located outside the left, right, top and bottom edges of the document. An additional step includes calculating a gray background pixel value of the at-least-one portion of the document using at least the histogram.

A second method of the invention is for determining a gray background value of a scanned document having left, right, top and bottom edges. The second method includes several steps. One step includes obtaining a scanned image, having pixel values, of a vertical strip of a scanning area of a scanner, wherein the vertical strip includes at least one portion of the document and includes at least one non-document area. Another step includes creating a histogram of the pixel values, of the vertical strip, located inside the left, right, top and bottom edges of the document while excluding from the histogram the pixel values, of the vertical strip, located outside the left, right, top and bottom edges of the document. An additional step includes calculating a gray background pixel value of the at-least-one portion of the document using at least the histogram.

A third method of the invention is for determining skew of a scanned document having a top and a bottom edge. The third method includes several steps. One step includes obtaining a scanned image using vertically-displaced successive horizontal scan lines, wherein the scanned image has pixel values for pixel locations, wherein the scanned image includes at least a portion of the document including a leading edge and includes a non-document area outside the leading edge, and wherein the leading edge is a first of the top or bottom edge encountered by the vertically-displaced successive horizontal scan lines. Another step includes determining points of the leading edge using changes in the pixel values and corresponding pixel locations. An additional step includes fitting a line to the points. A further step includes calculating the skew of the document using at least the slope of the line.

A fourth method of the invention is for determining skew of a scanned document having a left and a right edge. The fourth method includes several steps. One step includes obtaining a scanned image using horizontally-displaced successive vertical scan lines, wherein the scanned image has pixel values for pixel locations, wherein the scanned image includes at least a portion of the document including a leading edge and includes a non-document area outside the leading edge, and wherein the leading edge is a first of the left or right edge encountered by the horizontally-displaced successive vertical scan lines. Another step includes determining points of the leading edge using changes in the pixel values and corresponding pixel locations. An additional step includes fitting a line to the points. A further step includes calculating the skew of the document using at least the slope of the line.

Several benefits and advantages are derived from at least one of the first through fourth methods of the invention. In one example of the first and/or second methods, excluding the pixels located outside the edges in determining the gray background pixel value provides for a more accurate background estimation and correction. In one example of the third and/or fourth methods, fewer scan lines are required to be buffered in memory for determining enough points of a scanned document edge to which an accurate line is fit in calculating and correcting for skew.

### BRIEF DESCRIPTION OF THE DRAWINGS

FIG. 1 is a block diagram of a first method of the invention;

FIG. 2 is a block diagram of a second method of the invention;

FIG. 3 is a block diagram of a third method of the invention;

FIG. 4 is a block diagram of a fourth method of the invention;

FIG. 5 is a schematic diagram of an embodiment of a scanning area upon which a document has been placed, wherein the document is smaller than, and is skewed with respect to, the scanning area; and

FIG. 6 is a diagram of a top portion of the scanning area of FIG. 5 including a top portion of the document.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

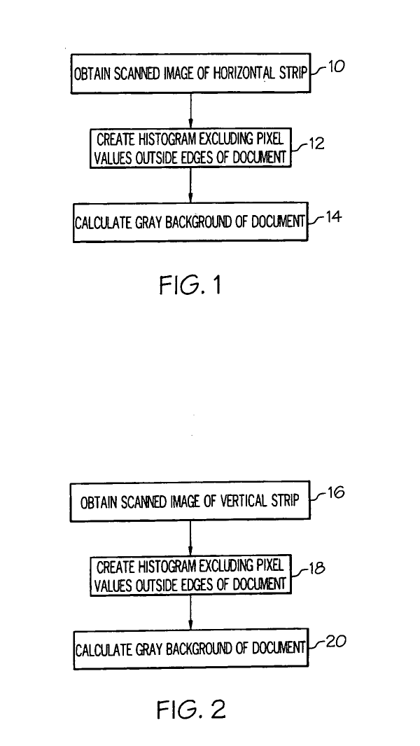

FIG. 1 is a block diagram of a first method of the invention which is for determining a gray background value of a scanned document having left, right, top and bottom edges. The first method includes steps a) through c). Step a) is labeled as “Obtain Scanned Image Of Horizontal Strip” in block 10 of FIG. 1. Step a) includes obtaining a scanned image, having pixel values, of a horizontal strip of a scanning area of a scanner, wherein the horizontal strip includes at least one portion of the document and includes at least one non-document area. Step b) is labeled as “Create Histogram Excluding Pixel Values Outside Edges Of Document” in block 12 of FIG. 1. Step b) includes creating a histogram of the pixel values, of the horizontal strip, located inside the left, right, top and bottom edges of the document while excluding from the histogram the pixel values, of the horizontal strip, located outside the left, right, top and bottom edges of the document. Step c) is labeled as “Calculate Gray Background Of Document” in block 14 of FIG. 1. Step c) includes calculating a gray background pixel value of the at-least-one portion of the document using at least the histogram.

For purposes of describing any of the methods of the invention, the term “scanned” includes scanners and includes digital cameras having two-dimensional pixel sensor arrays, and the terminology “gray background” includes gray background and includes background color. In one example of any of the methods of the invention, each pixel location includes a horizontal component and a vertical component.

It is noted that the first method has application in black and white scanners and in color scanners, as can be appreciated by those skilled in the art.

In a first enablement of the first method, step a) includes obtaining the scanned image of the horizontal strip after the entire scanning area of the scanner has been scanned. In another enablement, step a) includes obtaining the scanned image of the horizontal strip before the entire scanning area of the scanner has been scanned. In one employment of the first method, the scanned image is obtained from vertically-displaced successive horizontal scan lines. In one variation, the vertical displacement is toward the bottom edge of the document. In another variation, the vertical displacement is toward the top edge of the document. In one construction, the scanner includes a scan bar which is horizontally oriented and which is vertically displaced for successive scan lines. In another construction, the scanner includes a scan bar which is horizontally oriented and which is stationary, wherein the document is vertically displaced for successive scan lines.

In one application of the first method, the document is smaller than the scanning area. In the same or a different application, the document is skewed with respect to the scanning area.

In one extension of the first method, steps a) through c) are repeated for a different horizontal strip. In one variation, this provides for dynamically updating the calculated gray background pixel value of the document as the document is scanned. In one modification, step c) does not use a histogram from any horizontal strip which does not include any portion of the document, as can be appreciated by the artisan. In one illustration, the first method starts with a top-most horizontal strip and works toward a bottom-most horizontal strip wherein the sum of the horizontal strips equals the scanning area. In another illustration, the first method starts with a bottom-most horizontal strip and works toward a top-most horizontal strip wherein the sum of the horizontal strips equals the scanning area. In a further illustration, the horizontal strip covers the entire scanning area of the scanner.

In one employment of the first method, the scanner includes a platen cover, wherein step a) includes performing a scan using the scanner with the platen cover open. In this employment, the first method also includes the step of calculating an average of the pixel values, of the horizontal strip, located outside the left, right, top and bottom edges of the document and the step of replacing the value of the pixel values, of the horizontal strip, located outside the left, right, top and bottom edges of the document with values corresponding to a white-color value based at least on the average and the gray background pixel value of step d).

FIG. 2 is a block diagram of a second method of the invention which is for determining a gray background value of a scanned document having left, right, top and bottom edges. The second method includes steps a) through c). Step a) is labeled as “Obtain Scanned Image Of Vertical Strip” in block 16 of FIG. 2. Step a) includes obtaining a scanned image, having pixel values, of a vertical strip of a scanning area of a scanner, wherein the vertical strip includes at least a portion of the document and includes at least one non-document area. Step b) is labeled as “Create Histogram Excluding Pixel Values Outside Edges Of Document” in block 18 of FIG. 2. Step b) includes creating a histogram of the pixel values, of the vertical strip, located inside the left, right, top and bottom edges of the document while excluding from the histogram the pixel values, of the vertical strip, located outside the left, right, top and bottom edges of the document. Step c) is labeled as “Calculate Gray Background Of Document” in block 20 of FIG. 2. Step c) includes calculating a gray background pixel value of the at-least-one portion of the document using at least the histogram.

It is noted that the second method has application in black and white scanners and in color scanners, as can be appreciated by those skilled in the art.

In a first enablement of the second method, step a) includes obtaining the scanned image of the vertical strip after the entire scanning area of the scanner has been scanned. In another enablement, step a) includes obtaining the scanned image of the vertical strip before the entire scanning area of the scanner has been scanned. In one employment of the second method, the scanned image is obtained from horizontally-displaced successive vertical scan lines. In one variation, the horizontal displacement is toward the right edge of the document. In another variation, the horizontal displacement is toward the left edge of the document. In one construction, the scanner includes a scan bar which is vertically oriented and which is horizontally displaced for successive scan lines. In another construction, the scanner includes a scan bar which is vertically oriented and which is stationary, wherein the document is horizontally displaced for successive scan lines.

In one application of the second method, the document is smaller than the scanning area. In the same or a different application, the document is skewed with respect to the scanning area.

In one extension of the second method, steps a) through c) are repeated for a different vertical strip. In one variation, this provides for dynamically updating the calculated gray background pixel value of the document as the document is scanned. In one modification, step c) does not use a histogram from any vertical strip which does not include any portion of the document, as can be appreciated by the artisan. In one illustration, the second method starts with a left-most vertical strip and works toward a right-most vertical strip wherein the sum of the vertical strips equals the scanning area. In another illustration, the second method starts with a right-most vertical strip and works toward a left-most vertical strip wherein the sum of the vertical strips equals the scanning area. In a further illustration, the vertical strip covers the entire scanning area of the scanner.

In one employment of the second method, the scanner includes a platen cover, wherein step a) includes performing a scan using the scanner with the platen cover open. In this employment, the second method also includes the step of calculating an average of the pixel values, of the vertical strip, located outside the left, right, top and bottom edges of the document and the step of replacing the value of the pixel values, of the vertical strip, located outside the left, right, top and bottom edges of the document with values corresponding to a white-color value based at least on the average and the gray background pixel value of step d).

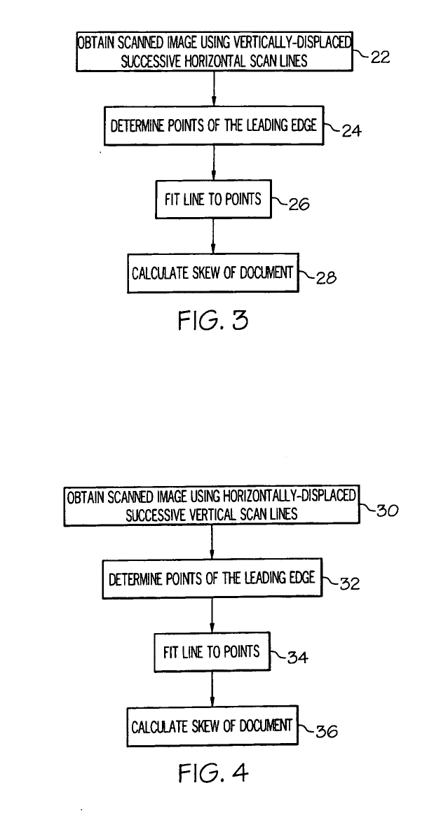

FIG. 3 is a block diagram of a third method of the invention which is for determining skew of a scanned document having a top and a bottom edge. The third method includes steps a) through d). Step a) is labeled as “Obtain Scanned Image Using Vertically-Displaced Successive Horizontal Scan Lines” in block 22 of FIG. 3. Step a) includes obtaining a scanned image using vertically-displaced successive horizontal scan lines, wherein the scanned image has pixel values for pixel locations, wherein the scanned image includes at least a portion of the document including a leading edge and includes a non-document area outside the leading edge, and wherein the leading edge is a first of the top or bottom edge encountered by the vertically-displaced successive horizontal scan lines. Step b) is labeled as “Determine Points Of The Leading Edge” in block 24 of FIG. 3. Step b) includes determining points of the leading edge using changes in the pixel values and corresponding pixel locations. Step c) is labeled as “Fit Line To Points” in block 26 of FIG. 3. Step c) includes fitting a line to the points determined in step b). Step d) is labeled as “Calculate Skew Of Document” in block 28 of FIG. 3. Step d) includes calculating the skew of the document using at least the slope of the line.

In one employment of the third method, step c) applies least squares line fitting to the points determined in step b). It is noted that the third method has application in black and white scanners and in color scanners, as can be appreciated by those skilled in the art.

In a first enablement of the third method, step a) includes obtaining the scanned image after the entire scanning area of the scanner has been scanned. In another enablement, step a) includes obtaining the scanned image before the entire scanning area of the scanner has been scanned. In one variation of the third method, the vertical displacement is toward the bottom edge of the document. In another variation, the vertical displacement is toward the top edge of the document. In one construction, the scanner includes a scan bar which is horizontally oriented and which is vertically displaced for successive scan lines. In another construction, the scanner includes a scan bar which is horizontally oriented and which is stationary, wherein the document is vertically displaced for successive scan lines. In this construction, the scanning area is considered to be the scanned image.

In one application of the third method, step c) fits the line to the points determined in step b) by fitting the line to a plurality of average points, wherein each average point is the average of a same number of different horizontally-successive ones of the points determined in step b). It is noted that the term “average” includes, without limitation, median, mean, mathematical average, weighted average, etc. In one modification, step c) applies least squares line fitting to the average points. It is noted that fitting the line to the average points provides for a more accurate skew estimation and correction.

In an extension of the third method, a gray background level of the scanned document is also determined. The extended third method also includes the additional steps of: determining the pixel locations of the left, right, top and bottom edges of the document using at least the calculated skew of the document; creating a histogram of the pixel values located inside the left, right, top and bottom edges of the document while excluding from the histogram the pixel values located outside the left, right, top and bottom edges of the document using at least the pixel locations of the edges; and calculating a gray background pixel value of the document using at least the histogram.

FIG. 4 is a block diagram of a fourth method of the invention which is for determining skew of a scanned document having a left and a right edge. The fourth method includes steps a) through d). Step a) is labeled as “Obtain Scanned Image Using Horizontally-Displaced Successive Vertical Scan Lines” in block 30 of FIG. 4. Step a) includes obtaining a scanned image using horizontally-displaced successive vertical scan lines, wherein the scanned image has pixel values for pixel locations, wherein the scanned image includes at least a portion of the document including a leading edge and includes a non-document area outside the leading edge, and wherein the leading edge is a first of the left or right edge encountered by the horizontally-displaced successive vertical scan lines. Step b) is labeled as “Determine Points Of The Leading Edge” in block 32 of FIG. 4. Step b) includes determining points of the leading edge using changes in the pixel values and corresponding pixel locations. Step c) is labeled as “Fit Line To Points” in block 34 of FIG. 4. Step c) includes fitting a line to the points determined in step b). Step d) is labeled as “Calculate Skew Of Document” in block 36 of FIG. 4. Step d) includes calculating the skew of the document using at least the slope of the line.

In one employment of the fourth method, step c) applies least squares line fitting to the points determined in step b). It is noted that the fourth method has application in black and white scanners and in color scanners, as can be appreciated by those skilled in the art. It also is noted that steps a) through d), as well as employing least squares line fitting in step c), are within the ordinary level of skill of the artisan.

In a first enablement of the fourth method, step a) includes obtaining the scanned image after the entire scanning area of the scanner has been scanned. In another enablement, step a) includes obtaining the scanned image before the entire scanning area of the scanner has been scanned. In one variation of the fourth method, the horizontal displacement is toward the right edge of the document. In another variation, the horizontal displacement is toward the left edge of the document. In one construction, the scanner includes a scan bar which is vertically oriented and which is horizontally displaced for successive scan lines. In another construction, the scanner includes a scan bar which is vertically oriented and which is stationary, wherein the document is horizontally displaced for successive scan lines. In this construction, the scanning area is considered to be the scanned image.

In one application of the fourth method, step c) fits the line to the points determined in step b) by fitting the line to a plurality of average points, wherein each average point is the average of a same number of different vertically-successive ones of the points determined in step b). It is noted that the term “average” includes, without limitation, median, mean, mathematical average, weighted average, etc. In one modification, step c) applies least squares line fitting to the average points. It is noted that fitting the line to the average points provides for a more accurate skew estimation and correction.

In an extension of the fourth method, a gray background level of the scanned document is also determined. The extended fourth method also includes the additional steps of: determining the pixel locations of the left, right, top and bottom edges of the document using at least the calculated skew of the document; creating a histogram of the pixel values located inside the left, right, top and bottom edges of the document while excluding from the histogram the pixel values located outside the left, right, top and bottom edges of the document using at least the pixel locations of the edges; and calculating a gray background pixel value of the document using at least the histogram.

The following discussion describes one example of employing some of the operations of the first and third methods, wherein the scanner includes a scan bar which is horizontally oriented and which is vertically displaced toward the bottom edge for successive scan lines, wherein the first horizontal strip starts at the top of the scanning area, and wherein a scanned image of the entire scanning area of the scanner has been obtained.

In step 1, an initial background estimation is made as follows. A histogram H of the first horizontal strip is performed:

$${H}_{1} ( l ) = {\sum }_{i = 1}^{M} {\sum }_{j = 1}^{W} [ f ( i , j ) = l ] \qquad 0 \leq l \leq 255$$

where W is the number of pixels of the horizontal width of the horizontal strip, M is the number of pixels of the vertical height of the horizontal strip, and f(i,j) is the intensity at pixel (i,j). An intensity of 0 corresponds to a blackest black, and an intensity of 255 corresponds to a whitest white. The gray level is calculated at which the histogram is maximum (peak) P₁:
P₁=min{g|g>T and H₁(g)≧H₁(i) for all i>T}
where T is a predefined threshold. This ensures that we don't have a dark document on a dark background. If P₁>T₁ (i.e. it is a valid peak), then we go to step 2, otherwise no background correction is performed for this strip. T₁ is a predefined threshold.

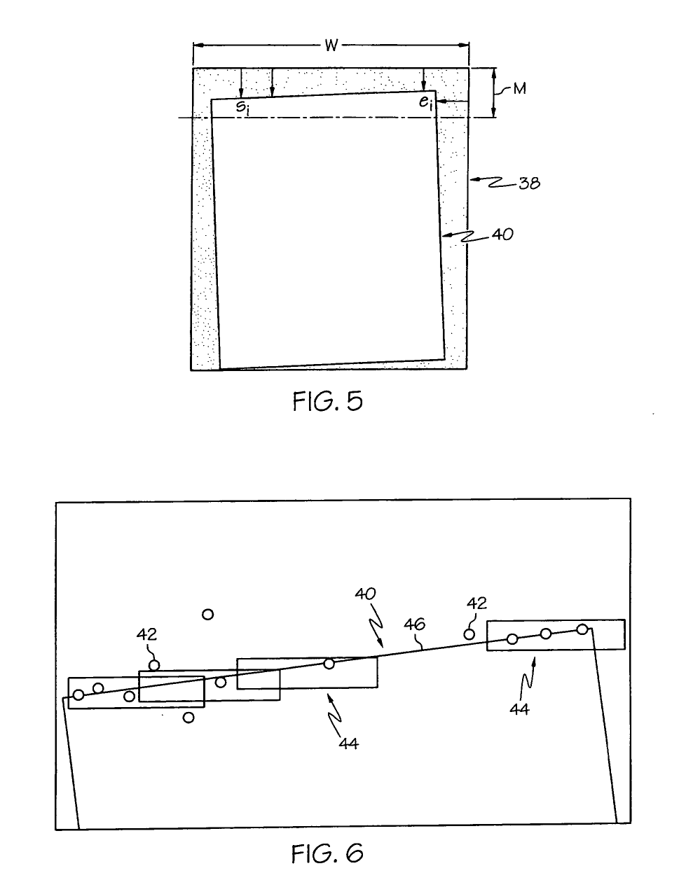

In step 2, document layout detection is performed. Referring to FIG. 5 which shows a scanned image of the entire scanning area 38 the scanner, we estimate the boundaries of the scanned document 40. This is done by scanning the values of each column j downwards until there is a substantial change in intensity E.
E=|f(i,j)−f(i−1,j)|
if E>T₂, we mark that location as the start of a document line sᵢ. Line i is then examined starting from the rightmost pixel going to the left.
E=|f(i,j)−f(i,j−1)|
If E>T₂, we mark that location as the end of document line i, eᵢ. We repeat this step for all columns of the strip, collecting the start and end pairs. {(sᵢ,eᵢ), 1≦i≦W} These pairs can also be collected by scanning each line i

a) from left to right
E=|f(i,j)−f(i, j−1)|
if E>T₂, we mark that location as the start of a document line sᵢ and

b) from right to left
E=|f(i,j)−f(i, j+1)|
If E>T₂, we mark that location as the end of document line i, eᵢ.

In step 3A, leading edge correction is performed. FIG. 6 shows points 42 representing detected intensity changes for locating the top edge of the document. For improved top edge detection, a sliding window 44 of size N replaces each start si with computed median of sⱼ for (i−N/2)<j<(i+N/2). A least squares line fitting is then applied to the calculated edges. The skew angle is the slope of the estimated line (shown as top edge 46 in FIG. 6).

In step 3B, document background estimation is performed. A histogram is performed of the document pixels.

$${H}_{2} ( l ) = {\sum }_{i = 1}^{M} {\sum }_{j = {s}_{i}}^{{e}_{i}} [ f ( i , j ) = l ] \qquad 0 \leq l \leq 255$$

We then calculate the gray level at which the histogram is maximum (peak) P₂:
P₂={min g|H₂(g)≧H₂(i) for all i≠g}
We then adjust document intensities by mapping the values to the range [0:P₂]. The statistics obtained from H₂ are much more accurate than H₁ in determining the document background intensity.

In step 4, dynamic background correction is performed. The left and right of each subsequent strip can also be estimated and a histogram can be obtained for the portion of the document lying in that strip in similar fashion to step 3B. This allows background statistics to be updated as the document is scanned. This can be useful in such cases where the background varies in different part of the document.

In step 5, outside black pixel removal is performed. The average intensity of outside pixels is calculated for each strip. If the platen cover is open and the outside intensity is much darker than the document background, the outside pixels are replaced with white.

Several benefits and advantages are derived from at least one of the first through fourth methods of the invention. In one example of the first and/or second methods, excluding the pixels located outside the edges in determining the gray background pixel value provides for a more accurate background estimation and correction. In one example of the third and/or fourth methods, fewer scan lines are required to be buffered in memory for determining enough points of a scanned document edge to which an accurate line is fit in calculating and correcting for skew.

The foregoing description of several methods of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for determining a gray background value of a scanned document having: left, right, top and bottom edges comprising the steps of:
a) obtaining a scanned image, having pixel values, of a horizontal strip of a scanning area of a scanner, wherein the horizontal strip includes at least one portion of the document and includes at least one non-document area;
b) creating a histogram of the pixel values, of the horizontal strip, located inside the left, right, top and bottom edges of the document while excluding from the histogram the pixel values, of the horizontal strip, located outside the left, right, top and bottom edges of the document; and
c) calculating a gray background pixel value of the at-least-one portion of the document using at least the histogram.

2. The method of claim 1, wherein the document is smaller than the scanning area.

3. The method of claim 1, wherein the document is skewed with respect to the scanning area.

4. The method of claim 1, wherein steps a) through c) are repeated for a different horizontal strip.

5. The method of claim 1, wherein the scanner includes a platen cover, wherein step a) includes performing a scan using the scanner with the platen cover open, and also including the step of calculating an average of the pixel values, of the horizontal strip, located outside the left, right, top and bottom edges of the document and the step of replacing the value of the pixel values, of the horizontal strip, located outside the left, right, top and bottom edges of the document with values corresponding to a white-color value based at least on the average and the gray background pixel value of step d).

6. A method for determining a gray background value of a scanned document having left, right, top and bottom edges comprising the steps of:
a) obtaining a scanned image, having pixel values, of a vertical strip of a scanning area of a scanner, wherein the vertical strip includes at least one portion of the document and includes at least one non-document area;
b) creating a histogram of the pixel values, of the vertical strip, located inside the left, right, top and bottom edges of the document while excluding from the histogram the pixel values, of the vertical strip, located outside the left, right, top and bottom edges of the document; and
c) calculating a gray background pixel value of the at-least-one portion of the document using at least the histogram.

7. The method of claim 6, wherein the document is smaller than the scanning area.

8. The method of claim 6, wherein the document is skewed with respect to the scanning area.

9. The method of claim 6, wherein steps a) through c) are repeated for a different vertical strip.

10. The method of claim 6, wherein the scanner includes a platen cover, wherein step a) includes performing a scan using the scanner with the platen cover open, and also including the step of calculating an average of the pixel values, of the vertical strip, located outside the left, right, top and bottom edges of the document and the step of replacing the value of the pixel values, of the vertical strip, located outside the left, right, top and bottom edges of the document with values corresponding to a white-color value based at least on the average and the gray background pixel value of step d).

11. A method for determining skew of a scanned document having a top and a bottom edge comprising the steps of:
a) obtaining a scanned image using vertically-displaced successive horizontal scan lines, wherein the scanned image has pixel values for pixel locations, wherein the scanned image includes at least a portion of the document including a leading edge and includes a non-document area outside the leading edge, and wherein the leading edge is a first of the top or bottom edge encountered by the vertically-displaced successive horizontal scan lines;
b) determining points of the leading edge using changes in the pixel values and corresponding pixel locations;
c) fitting a line to the points determined in step b); and
d) calculating the skew of the document using at least the slope of the line.

12. The method of claim 11, wherein step c) applies least squares line fitting to the points determined in step b).

13. The method of claim 11, wherein step c) fits the line to the points determined in step b) by fitting the line to a plurality of average points, wherein each average point is the average of a same number of different horizontally-successive ones of the points determined in step b).

14. The method of claim 13, wherein step c) applies least squares line fitting to the average points.

15. The method of claim 11, also for determining a gray background level of the scanned document, and also including the steps of:
e) determining the pixel locations of the left, right, top and bottom edges of the document using at least the calculated skew of the document;
f) creating a histogram of the pixel values located inside the left, right, top and bottom edges of the document while excluding from the histogram the pixel values located outside the left, right, top and bottom edges of the document using at least the pixel locations determined in step e); and
g) calculating a gray background pixel value of the document using at least the histogram.

16. A method for determining skew of a scanned document having a left and a right edge comprising the steps of:
a) obtaining a scanned image using horizontally-displaced successive vertical scan lines, wherein the scanned image has pixel values for pixel locations, wherein the scanned image includes at least a portion of the document including a leading edge and includes a non-document area outside the leading edge, and wherein the leading edge is a first of the left or right edge encountered by the horizontally-displaced successive vertical scan lines;
b) determining points of the leading edge using changes in the pixel values and corresponding pixel locations;
c) fitting a line to the points determined in step b); and
d) calculating the skew of the document using at least the slope of the line.

17. The method of claim 16, wherein step c) applies least squares line fitting to the points determined in step b).

18. The method of claim 16, wherein step c) fits the line to the points determined in step b) by fitting the line to a plurality of average points, wherein each average point is the average of a same number of different vertically-successive ones of the points determined in step b).

19. The method of claim 18, wherein step c) applies least squares line fitting to the average points.

20. The method of claim 16, also for determining a gray background level of the scanned document, and also including the steps of:
e) determining the pixel locations of the left, right, top and bottom edges of the document using at least the calculated skew of the document;
f) creating a histogram of the pixel values located inside the left, right, top and bottom edges of the document while excluding from the histogram the pixel values located outside the left, right, top and bottom edges of the document using at least the pixel locations determined in step e); and
g) calculating a gray background pixel value of the document using at least the histogram.
